(19) United States
(12) Patent Application Publication
(10) Pub. No.: US 2009/0125168 A1
(43) Pub. Date: May 14, 2009

(54) TAKEOFF AND LANDING PERFORMANCE INDICATOR FOR FIXED WING AIRCRAFT

(75) Inventor: Paul A. Voisin, Alto, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: L-3 COMMUNICATIONS AVIONICS SYSTEMS, INC., Grand Rapids, MI (US)

(21) Appl. No.: 11/718,907

(22) PCT Filed: Nov. 9, 2005
(86) PCT No.: PCT/US05/40655

§ 371 Date: May 9, 2007

Related U.S. Application Data
(60) Provisional application No. 60/522,813, filed on Nov. 10, 2004.

(51) Int. Cl. G06F 19/00; G06G 7/70

(52) U.S. Cl. 701/15

(57) ABSTRACT

A runway performance monitor and method for an aircraft, includes providing a control, and monitoring aircraft performance. The control has baseline performance data of the aircraft during takeoff and/or landing. The control compares actual performance of the aircraft during takeoff and/or landing with the baseline performance data and calculates predicted information relevant to takeoff velocity and/or landed velocity. The control may determine braking point data and/or takeoff point data for that aircraft as a function of aircraft performance and runway location and length. The braking point data defines a location relevant to decelerating of the aircraft to a landed velocity. The takeoff point data defines a location relevant to accelerating of the aircraft to takeoff velocity. A display may be provided to display the information relevant to takeoff velocity and/or landed velocity.

### BACKGROUND OF THE INVENTION

The present invention is directed to a runway performance monitor and method for a fixed wing aircraft and, in particular, to a monitor and method for assisting in landing and/or takeoff of the aircraft.

It is commonly accepted that the takeoff and landing portions of the flight present the greatest risk of a crash. Upon landing, the pilot must decide, based upon the knowledge and experience of the pilot, the type of aircraft, the weather conditions, and the like, whether the pilot will be able to safely bring the aircraft to a landed velocity or abort the landing and go around to make another attempt. The landed velocity is one at which the aircraft is brought to essentially a zero velocity or a velocity appropriate for taxiing the aircraft off the runway. A pilot also must often make a decision whether or not to abort a takeoff. The pilot must abort a takeoff if the pilot is not convinced that the aircraft can achieve takeoff velocity prior to the end of the runway. The option for aborting a takeoff is to bring the aircraft to a landed velocity before the end of the runway. The ability to achieve takeoff velocity before the end of the runway can be affected by the length of the runway, the performance of the engines, the weight of the aircraft, the type of aircraft, and the like. Pilots develop a personal sense of the conditions under which a landing or a takeoff should be aborted. Obviously, such a sense is influenced by the experience of the pilot, in general, and with the particular aircraft being flown. However, as a human being, a pilot's sense is affected by such factors as emotional state, lack of sleep, visual conditions, and the like. Moreover, factors, such as the weight of the aircraft, are determined by other personnel who can, likewise, be subject to errors.

### SUMMARY OF THE INVENTION

The present invention is directed to a method and apparatus that assists the pilot in making abort decisions on takeoff and landing. The present invention provides an objective analysis of the ability of the pilot to brake the aircraft to a landed velocity and/or accelerate the aircraft to a takeoff velocity taking into account the length of the runway. The present invention is also capable of monitoring the acceleration and deceleration performance of the aircraft and utilizing such information to inform the pilot on the likelihood that the pilot will be able to bring the aircraft to a landed velocity or will be able to reach takeoff velocity based upon actual conditions affecting these parameters.

A runway performance monitor and method for a fixed wing aircraft according to an aspect of the invention includes providing a control having information regarding runway location and length. The control determines braking point data and takeoff point data for that aircraft as a function of aircraft performance and runway location and length. Braking point data is a location relevant to decelerating of the aircraft to a landed velocity. Takeoff point data is location information relative to accelerating the aircraft to a takeoff velocity.

A runway performance monitor and method for a fixed wing aircraft, according to another aspect of the invention, includes providing a control having baseline performance data of the aircraft during at least one takeoff and/or landing. The control monitors actual performance data of the aircraft during takeoff and/or landing of the aircraft. The control compares actual performance of the aircraft with the baseline performance data and calculates predicted information relevant to either takeoff velocity and/or landed velocity.

The control may develop the baseline performance data from operation of the aircraft during a calibration takeoff and/or a calibration landing or may develop the baseline performance data from ongoing operation of the aircraft. The baseline performance data and the actual performance data may be made up of aircraft acceleration data which may be expressed as a function of aircraft velocity. The distance to takeoff velocity and/or landed velocity may be repetitively calculated during takeoff or landing of the aircraft.

The present invention may further include a visual display. The control displays with the visual display the braking point data and/or the takeoff point data. The control may display the particular location of takeoff velocity and/or landed velocity on a proportional runway symbol and may provide an indication when the predicted location of the takeoff velocity and/or landed velocity is beyond the end of the runway. The indication may be displayed in different colors when the takeoff velocity and/or landed velocity is beyond the end of the runway.

Aircraft velocity data, positional data and/or time data may be provided from a satellite positioning system, such as a global positioning system. Data may be provided from either conventional airport data or manually inputted runway data. The baseline data may include a plurality of baseline datasets. Each of the datasets is for different systems used to decelerate the aircraft.

While the invention is exceptionally flexible and is capable of use on aircraft of various configurations, sizes, and capabilities, it is particularly useful with aircraft that do not have extensive instrumentation, such as small corporate jets, cargo planes, and the like. However, the invention is equally useful with commercial jetliners, and the like. Indeed, the invention is not even limited to fixed wing aircraft, but may find application to essentially any aircraft or vehicle, in general.

These and other objects, advantages and features of this invention will become apparent upon review of the following specification in conjunction with the drawings.

### BRIEF DESCRIPTION OF THE DRAWINGS

FIGS. 1a-1c illustrate a display of runway performance data, according to the invention;

FIG. 2 is an illustration of baseline versus predicted performance of a fixed wing aircraft;

FIG. 3 is a chart illustrating calculation of distance to takeoff velocity;

FIGS. 4a-4c are illustrations of an alternative embodiment of a display, according to the invention; and

FIG. 5 is a block diagram of a runway performance monitor, according to the invention.

### DESCRIPTION OF THE PREFERRED EMBODIMENT

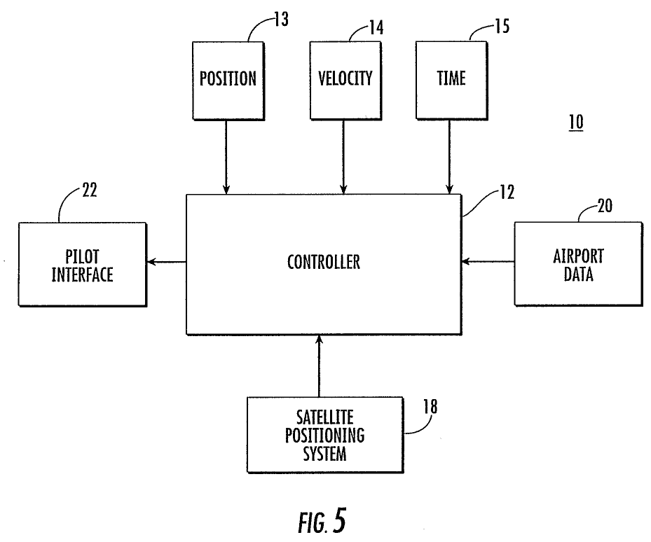

Referring now specifically to the drawings, and the illustrative embodiments depicted therein, a performance monitor 10 for a fixed wing aircraft includes a controller 12 and one or more inputs for providing data to controller 12 regarding performance of the aircraft (FIG. 5). In the illustrative embodiment, the inputs include position input 13, velocity input 14 and time input 15. As is well understood by the skilled artisan, inputs 13-15 may be provided by a satellite positioning system, such as a GPS unit 18. However, the present invention comprehends various techniques for inputting performance data to controller 12 and is not intended to be limited to any particular hardware implementation. Controller 12 receives airport data 20, namely, runway length as well as coordinates of the runway. Such airport data is available as a database for virtually all commercially accessible airports. However, the airport data may also be input manually. All that is required are data points showing the geographic location of at least the ends of the runway. This data may be obtained from a handheld GPS unit, a map of the airstrip, or the like. This ability to manually input airport data provides exceptional flexibility by allowing performance monitor 10 to be used with dirt airstrips, with military aircraft, in under-developed areas, and the like.

Performance monitor 10 additionally outputs data, such as to a pilot interface 22. However, it should be understood that controller 12 may alternatively provide information to an automatic controller, such as autopilot, to take control of the aircraft away from the pilot. However, the invention is illustrated in connection with a pilot interface 22 which is illustrated as a visual display. Other forms of display may be utilized, such as audible alarms, and the like.

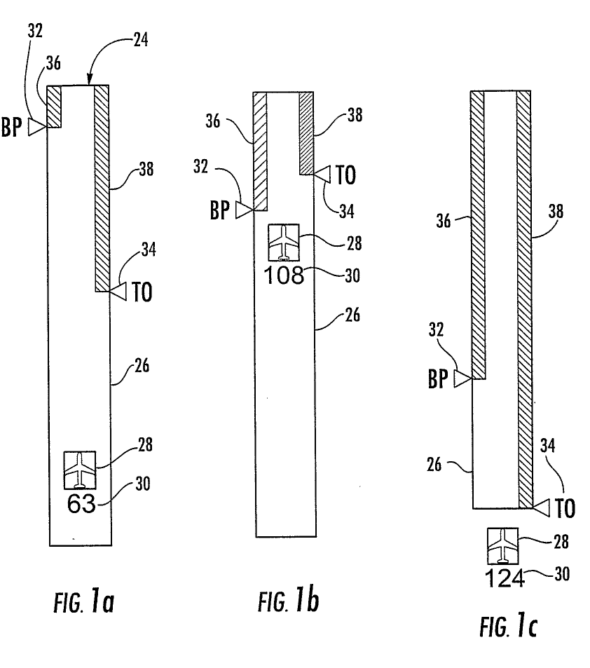

Pilot interface 22 may display takeoff and landing performance data to a pilot, such as in the form of a graphic 24 which illustrates a depiction of a runway 26 and a representation 28 of the present position of the aircraft with respect to runway 26 as well as the velocity of the aircraft at 30 (FIG. 1). Graphic 24 may also display a brake point data indicator 32 and a takeoff data indicator at 34. Brake point data indicator 32 represents a location relevant to deceleration of the aircraft to a landed velocity, such as taxi velocity. Takeoff point data indicator 34 represents a location relative to acceleration of the aircraft to a takeoff velocity. In the illustrative embodiment, brake point data indicator 32 represents a location on the runway beyond which the aircraft will likely not successfully decelerate to landed velocity, given the aircraft's present velocity and acceleration, without going off the end of the runway. In the illustrative embodiment, takeoff point indicator 34 represents a location on the runway where the aircraft likely will achieve takeoff velocity given its present position, velocity and acceleration.

Graphic 24 may additionally include a brake point strip 36 to further enhance the visualization of brake point data and a takeoff strip 38 to assist the display of takeoff data, namely, the respective distances to the end of the runway. Display 24 may optionally present strips 36 and 38 in various colors depending upon the relationship of the aircraft to the brake point and the takeoff point in order to further assist the pilot in interpreting the performance data. In the illustrative embodiment, graphic 24 is dynamic and is repetitively updated as the aircraft performance data is updated as the pilot attempts takeoff or landing of the aircraft. This allows graphic 24 to more accurately display the ability of the pilot to successfully decelerate the aircraft to a landed velocity before the end of the runway or accelerate the aircraft to a takeoff velocity before the end of the runway.

FIG. 1a illustrates a typical takeoff on a long runway. With the aircraft shown at 28 traveling 63 nautical miles per hour (knots), the takeoff data indicator 34 shows that the pilot should be readily able to reach takeoff velocity given the position and velocity of the aircraft. Brake point data indicator 32 indicates a location beyond which the aircraft would not be able to decelerate to a landed velocity within the distance indicated by brake point strip 36 given the present position, velocity and acceleration of the aircraft. As the aircraft accelerates, brake point 32 should move toward the aircraft representation 28. As will be discussed in more detail below, takeoff data indicator 34 may change as additional data is gathered regarding performance of the aircraft.

FIG. 1b illustrates a situation, such as a takeoff or landing on a short runway. Representation 28 shows that the aircraft has a velocity of 108 knots and is quickly approaching the brake point beyond which the aircraft would be unable to decelerate to a landed velocity within the confines of the runway and given the present velocity of the aircraft. The pilot is also informed that the takeoff indicator 34 indicates that the pilot should be able to achieve takeoff velocity before the end of the runway. Once the aircraft passes brake point 32, the aircraft is committed to either flying, if the aircraft is taking off, or going around, if the aircraft is landing. As the aircraft passes the braking point, graphic 24 may indicate this information to the pilot. One way to do so would be change the color of the display. For example, brake point strip 36 may change from green to red. Also, takeoff strip 38 may change from green to yellow, then to red, or the like, as the takeoff point moves within a high risk region of the end of the runway. An example may be when the takeoff point reaches the final third of the runway. Alternatively, one or more strips 36, 38 may switch from a solid to a flashing display, or the like.

FIG. 1c illustrates a representative landing, in particular a short-runway landing. Because the aircraft illustrated at 28 is already at flight speed, takeoff point indicator 34 shows that the aircraft will be at takeoff velocity anywhere along the runway shown at 26. Brake point indicator 32 shows that, at the present velocity of 124 knots, the aircraft should touch down and begin deceleration before brake point indicator 32 with respect to the runway in order to decelerate to landed speed prior to the end of the runway. As the aircraft decreases in airspeed, brake point indicator 32 should recede away from the aircraft indicator 28. These examples are for illustration only and are not intended to indicate the only modes of operation of the invention.

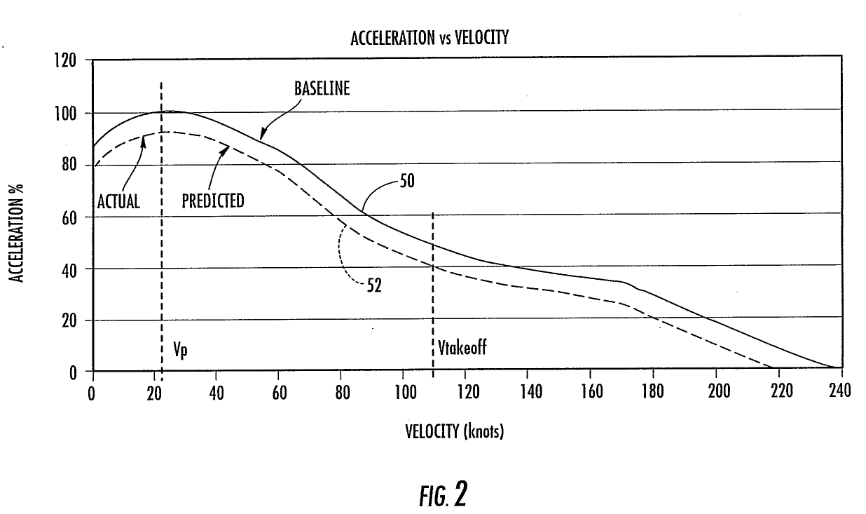

The present invention also provides a unique technique for monitoring the performance of the aircraft in order to determine a point beyond which the pilot will likely not be able to successfully decelerate the aircraft to a landed velocity at the present velocity as well as the point beyond which the pilot will not likely be able to successfully achieve the takeoff velocity from the present velocity. This may be accomplished by utilizing baseline data for the aircraft and determining the predicted performance of the aircraft with respect to its baseline. Referring to FIG. 2, a baseline curve 50 of acceleration versus velocity is shown for a hypothetical aircraft during takeoff. The baseline, in the illustrative embodiment, may be obtained by performing a takeoff of that aircraft while monitoring the velocity and acceleration of the aircraft, such as by using a GPS receiver 18 or inputs 13-15. This may be accomplished under standard load conditions in order to provide an appropriately positioned baseline curve.

The baseline may be established during a calibration flight. The calibration flight may be repeated from time to time, especially if the aircraft has undergone modification, such as a change of engine, propeller, or the like. Also, it may be repeated if the aircraft is being flown in a significantly different environment. The baseline data may also be updated routinely during normal operation of the aircraft.

Once a baseline is established, the actual performance of the aircraft, illustrated as actual/predicted curve 52, should have the same overall outline as the baseline but shifted up or down, as viewed in FIG. 2, with respect to the baseline. For example, if the baseline is taken with the aircraft at full weight, the actual/predicted performance curve 52 for a partially loaded aircraft may be a curve that is above the baseline. Also, by way of example, if the engines of the aircraft are performing less than they did during the baseline, the curve may be below that of the baseline, as viewed in FIG. 2.

Utilizing the baseline data, controller 12 determines a distance to takeoff velocity using equations 1-3. For each velocity Vn from Vp to Vtakeoff, the following is computed:

dT=dV/aP (1)

S(Vn)=(½*aP*dT*dT)+(Vn+dV/2)*dT+S(Vn−1) (2)

Vn=Vn+dV (3)

Where:
aP=predicted acceleration as a function of velocity
dV=2 knots (integral step size)
Vp=present velocity
S(Vn)=total distance required to achieve velocity Vn from present velocity.

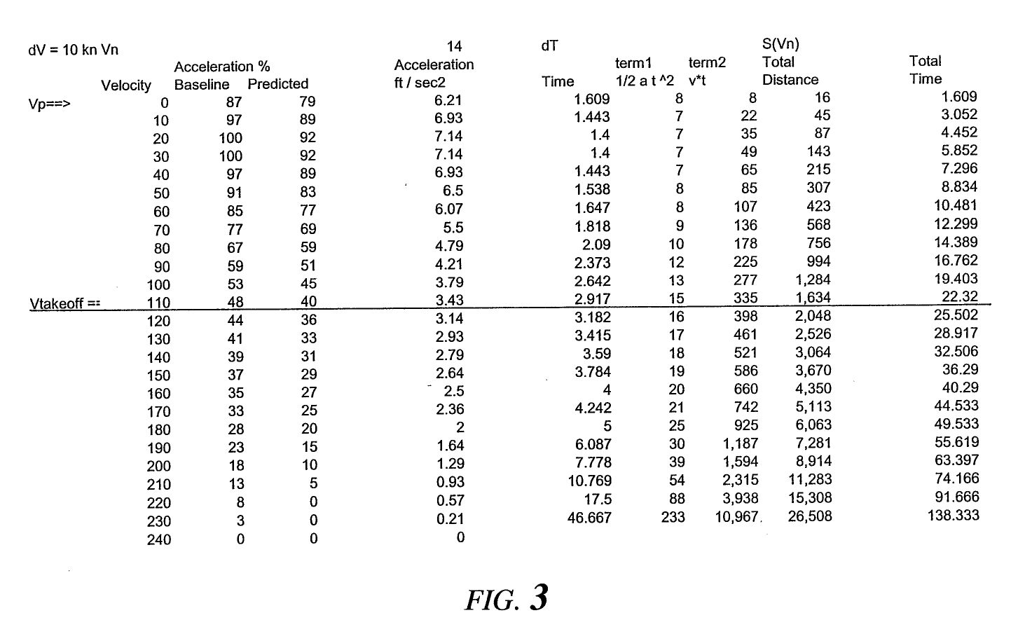

Equation 1 establishes a change in time from the present velocity to the next incremental velocity using the predicted acceleration rate from the actual/predicted curve 52 using actual velocity and acceleration data up to that time in the takeoff or landing. The incremental velocity may be set, such as in the illustrated embodiment, at 2 knots. Clearly, the incremental velocity may be chosen at any appropriate level. Equation 2 determines a distance to the takeoff velocity from the present position. Equation 2 uses time, acceleration and the velocity to obtain such distance. Finally, equation 3 obtains the next incremental velocity. FIG. 3 illustrates typical values for the elements of equation 2. It can be seen from FIG. 3 that calculations are performed for each integral step between the present velocity and the takeoff velocity using the actual acceleration compared to the baseline acceleration. The calculation is repeated according to a desired repetition rate, which can be more frequent than the integral step size. As the aircraft increases in velocity toward the takeoff velocity, the value of predicted acceleration compared to the baseline acceleration becomes more well known. Therefore, the location of the takeoff data point becomes more precisely established.

A similar process may be performed for calculating the braking point data for the aircraft. A baseline deceleration curve (deceleration is a negative acceleration and, therefore, can also be referred to as acceleration) may be obtained utilizing the actual aircraft during the braking calibration run. The actual deceleration of the aircraft can be compared with the deceleration baseline in order to determine the brake point data for the aircraft at any given velocity. It should be apparent that controller 12 can concurrently calculate and display both the brake point data and takeoff data for the aircraft in real time as the aircraft is either landing or taking off.

In determining brake point data, controller 12 may take into account multiple possible systems that may be utilized by the aircraft to decelerate the aircraft. These may include reverse engine thrust, mechanical brakes, and even drogue chutes. Separate baseline curves can be established for each such system, and the controller may take into account one or more of the deceleration baseline curves depending upon the systems that are being utilized to decelerate the aircraft under actual conditions.

Advantageously, the relationship between actual acceleration/deceleration and baseline acceleration/deceleration is generally linear. It is based upon the relationship in physics of force=mass multiplied by acceleration. Therefore, the present invention utilizes the ability to predict the acceleration of the aircraft from the actual present acceleration and the baseline acceleration by utilizing this linear relationship. As previously set forth, the ability to predict acceleration increases as the aircraft moves closer to takeoff velocity or landed velocity. While the invention is illustrated with baseline curves that are actually created by measurements of performance of the aircraft during a calibration takeoff and/or landing, the invention comprehends the use of baseline data regardless of how obtained. For example, baseline data may be obtained by calculation or by establishing baseline curves for families of aircraft, or the like.

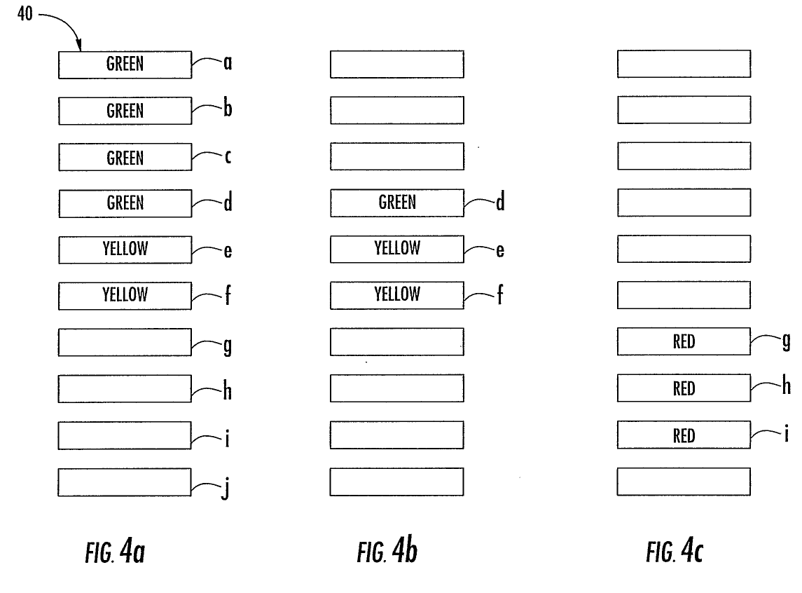

An alternative graphic 40 is shown in FIGS. 4a-4c to illustrate that information on brake point data, and takeoff data may be displayed in various formats to the pilot. Referring to FIG. 4a, the indicator lights each are illustrated as representing 20 feet of runway per light a-j. FIG. 4a shows the pilot with more than 100 feet (6×20 feet) for stopping the aircraft as illustrated by green and yellow indicators a-f. FIG. 4b illustrates a situation where only indicators d, e and f are illustrated which shows that the margin is now only 60 feet to stop the aircraft. FIG. 4c shows that indicators g, h and i are illuminated and all are red. The presence of illuminated indicators g, h and i informs the pilot that he is committed to taking off, because the aircraft is past the brake point, with 60 feet of margin to achieve takeoff velocity. Alternatively, FIG. 4c may show the pilot during the landing mode that he should do a go-around with 60 feet of margin to achieve takeoff velocity. Other examples of indicators will suggest themselves to the skilled artisan.

The invention is illustrated for use with visual indicators. Alternatively, audible indicators could also be utilized. The audible indicators are considered to be less intuitive and require a longer period for interpretation by the pilot. Because the present invention is capable of providing common data to the pilot whether the pilot is landing the aircraft or taking off, the pilot will become familiar with the data and understand the applicability of the same data to both the aborting of a landing as well as the aborting of a takeoff. Moreover, the data can be obtained utilizing either existing hardware already on the aircraft or by utilizing a separately installed instrument. The ability to calibrate the data to the aircraft reduces the necessity for specialized configuration of the hardware to the particular aircraft.

It is also seen that the present invention provides a unique performance monitor for monitoring the performance of the aircraft during landing and/or takeoff of the aircraft. By comparing the actual performance of the aircraft to calibrate performance, the controller may be able to detect abnormal occurrences, such as sudden decrease in thrust, or the like, which may allow additional indications to the pilot, for example, of the desirability to abort a takeoff. Also, the performance indicator may indicate a necessity for unscheduled maintenance, and the like.

The present invention may be used with conventional data that is available for most airports and landing strips. It may also be useful with landing strips that are not plotted with GPS coordinates, such as dirt strips and other non-conventional strips. This is because the only information that is required is the length of the runway and the position of the aircraft with respect to the endpoints of the runway. The airport data could be entered manually

Changes and modifications in the specifically described embodiments can be carried out without departing from the principles of the invention which is intended to be limited only by the scope of the appended claims, as interpreted according to the principles of patent law including the doctrine of equivalents.

1. A runway performance monitor for a fixed wing aircraft, comprising:
a control, said control having baseline performance data of the aircraft during at least one of a prior takeoff and a prior landing of the aircraft;
said control monitoring actual performance data of the aircraft during at least one of a present takeoff and a present landing; and
said control comparing actual performance of the aircraft with the baseline performance data and calculating predicted information relevant to at least one chosen from takeoff velocity and landed velocity.

2. The performance monitor as claimed in claim 1 wherein said control develops said baseline performance data from operation of the aircraft during at least one of a calibration takeoff and a calibration landing.

3. The performance monitor as claimed in claim 1 wherein said baseline performance data and said actual performance data comprise aircraft acceleration data.

4. The performance monitor as claimed in claim 3 wherein said baseline performance data and said actual performance data comprise aircraft acceleration as a function of aircraft velocity.

5. The performance monitor as claimed in claim 1 wherein said control repetitively calculates the predicted information relevant to at least one of takeoff velocity and landed velocity during the takeoff or landing of the aircraft.

6. The performance monitor as claimed in claim 1 wherein the predicted information relevant to takeoff velocity defines a location relevant to accelerating the aircraft to takeoff velocity.

7. The performance monitor as claimed in claim 1 wherein the predicted information relevant to the landed velocity defines a location relevant to decelerating the aircraft to a landed velocity.

8. The performance monitor as claimed in claim 1 including a visual display, said control displaying with said visual display the predicted information relevant to at least one of takeoff velocity and landed velocity.

9. The performance monitor as claimed in claim 8 wherein said control displays the predicted information relevant to at least one of takeoff velocity and landed velocity on a proportional runway symbol.

10. The performance monitor as claimed in claim 8 wherein said control provides an indication when the predicted information predicts that achieving at least one of takeoff velocity and landed velocity would occur beyond the end of the runway.

11. The performance monitor as claimed in claim 10 wherein said control provides said indication by displaying the predicted information in different colors.

12. The performance monitor as claimed in claim 1 including a satellite positioning system, said satellite positioning system providing at least, velocity data, positional data and time data to said control.

13. The performance monitor as claimed in claim 1 including input for said control of at least one chosen from conventional airport data and manually input runway data.

14. The performance monitor as claimed in claim 1 wherein said baseline data comprises a plurality of baseline data sets, one for each of a different system used to decelerate the aircraft.

15. A method of monitoring runway performance of a fixed wing aircraft, comprising:
providing baseline performance data of the aircraft during at least one of a prior takeoff and a prior landing of the aircraft;
monitoring actual performance data of the aircraft during at least one of a present takeoff and a present landing; and
comparing the actual performance of the aircraft with the baseline performance data and calculating predicted information relevant to at least one chosen from takeoff velocity and landed velocity.

16. The method as claimed in claim 15 including developing said baseline performance data from operation of the aircraft during at least one of a calibration takeoff and a calibration landing.

17. The method as claimed in claim 15 wherein said baseline performance data and said actual performance data comprise aircraft acceleration data.

18. The method as claimed in claim 17 wherein said baseline performance data and said actual performance data comprise aircraft acceleration as a function of aircraft velocity.

19. The method as claimed in claim 15 including repetitively calculating the predicted information relevant to at least one of takeoff velocity and landed velocity during the takeoff or landing of the aircraft.

20. The method as claimed in claim 15 wherein the predicted information relevant to takeoff velocity defines a location relevant to accelerating the aircraft to takeoff velocity.

21. The method as claimed in claim 15 wherein the predicted information relevant to landed velocity defines a location relevant to decelerating the aircraft to a landed velocity.

22. The method as claimed in claim 15 including providing a visual display and displaying with said visual display the predicted information relevant to at least one of takeoff velocity and landed velocity.

23. The method as claimed in claim 22 wherein said displaying includes displaying the predicted information relevant to at least one of takeoff velocity and landed velocity on a proportional runway symbol.

24. The method as claimed in claim 22 wherein said displaying includes providing an indication when the predicted information predicts that achieving at least one of takeoff velocity and landed velocity would occur beyond the end of the runway.

25. The method as claimed in claim 24 wherein said displaying includes displaying that indication by displaying the predicted information in different colors.

26. The method as claimed in claim 15 including providing a satellite positioning system and providing with said satellite positioning system at least, velocity data, positional data and time data.

27. The method as claimed in claim 15 including providing airport data from at least one chosen from conventional airport data and manually input runway data.

28. The method as claimed in claim 15 wherein said baseline data comprises a plurality of baseline data sets, one for each of a different system used to decelerate the aircraft.
